(19) United States
(12) Patent Application Publication
(10) Pub. No.: US 2013/0004412 A1
(43) Pub. Date: Jan. 3, 2013

(54) SYNTHESIS OF PALLADIUM BASED METAL OXIDES BY SONICATION

(75) Inventor: Sivasankaran Sankaranarayana Iyer, Udupi (IN)

(73) Assignee: Manipal University

(21) Appl. No.: 13/505,351

(22) PCT Filed: Aug. 1, 2011
(86) PCT No.: PCT/IB2011/053412

§ 371 Date: May 1, 2012

(30) Foreign Application Priority Data
Jun. 16, 2011 (IN) 2042/CHE/2011
Aug. 1, 2011 (IB) 2011/053412

(51) Int. Cl. B01J 19/10; C01G 21/02

(52) U.S. Cl. 423/594.9; 204/157.42

(57) ABSTRACT

Provided herein are aqueous sonolysis methods involving mixing a precursor transition metal salt, with a Pd-water slurry and sonicating the resulting reaction mixture to synthesize the palladium-based transition metal oxides. Also provided herein are palladium-based transition metal oxides.

### CROSS REFERENCE TO RELATED APPLICATIONS

This application claims priority from Indian Patent Application Serial No. 2042/CHE/2011, filed Jun. 16, 2011, the contents of which are incorporated herein by reference.

### BACKGROUND

There is a high demand for palladium based, bi- and multimetallic oxides (i.e., Pd-based metal oxides), e.g., in various applications in the automotive, chemical, electronic, health care, energy, water treatment and pollution control industries. Current methods of producing palladium-based metal oxides are energy intensive, time consuming, and require a lot of chemicals, and, therefore, are not environmentally benign. Currently practiced methods, such as, wet chemical or hydrothermal processes, pyrolysis, or microwave assisted processes generally require temperatures greater than 100° C. The hydrothermal process also requires at least two steps and employs sodium hydroxide or ammonium hydroxide, which may be problematic to handle in large scale synthesis. Thus, there is a need for faster, safer and/or environmentally friendlier methods for producing palladium based metal oxides, e.g., in large scale production of such metal oxides.

### SUMMARY

The present technology provides novel methods of producing Pd-based transition metal oxide materials using aqueous sonolysis. The methods include sonolyzing a mixture including Pd(0) or a precursor thereof, water and a first metal salt including a metal ion of formula M¹(n+), wherein M¹ is any metal, other than Pd, having an oxidation state n+, and n is 2 or 3, to provide a Pd-based metal oxide that includes Pd, M¹ and oxygen. The method can be carried out in a single step and/or in a single pot. With the proper selection of precursor metal salts, the method provides facile syntheses of tailor-made metal oxides, for example, and without limitation, of the general formula [Pd—M²—O], wherein M¹ and M² are independently any metal other than palladium. Such a single-step/single-pot method is faster than the conventional two-step wet-chemical/hydrothermal method, which is frequently used for synthesizing metal oxides. The methods provided herein are also environmentally benign because they do not require the use of any chemicals other than the precursor metal salts and water. The methods provided herein also do not require high temperature, for example, and without limitation, temperatures greater than 100° C., and can be carried out at temperatures equal to or less than 100° C.

The Pd-based metal oxides produced by the present methods may be used as aqueous slurries or may be dried to provide a powder. A Pd-based metal oxide slurry may be centrifuged and/or heated to remove volatiles and produce the dry Pd-based metal oxide powder.

### BRIEF DESCRIPTION OF THE DRAWINGS

FIGS. 1A-1F depict SEM images of the oxide particles prepared according to the methods exemplified in Example 1 below: FIG. 1A (Pd—Co—O—C), FIG. 1B (Pd—Fe—O—C—S), FIG. 1C (Pd—Cu—Fe—O—C—S), FIG. 1D (Pd—Cu—O—S—C), FIG. 1E (Pd—Cu—O—C), and FIG. 1F (Pd—Mn—O—C).

FIG. 2 depicts a scanning electron microscope-energy dispersive X-Ray spectroscopy (SEM-EDX) spectrum of a Pd-based metal oxide of general formula Pd—Cu—O—C, whose components are specified in Table 1.

FIG. 3 depicts an X-Ray Powder diffraction pattern of a Pd-based metal oxide of general formula Pd—Cu—O—C, whose components are specified in Table 1.

FIG. 4 depicts a histogram showing the size distribution of Pd—Cu—O—C particles prepared in Example 1.

FIGS. 5A and 5B depicts histograms showing the size distribution of Pd—Cu—O—C particles prepared in Example 6, experiment numbers 2 and 7, respectively. Mean particle size is 0.8 μm in FIG. 5A and is 5.7 μm in FIG. 5B.

FIGS. 6A and 6B depict SEM images of the Pd-oxide particles prepared according to Example 6, experiment numbers 2 and 7, respectively. Magnification in each image is 100,000 times.

### DETAILED DESCRIPTION

The following terms are used throughout this disclosure as defined below.

As used herein, unless otherwise stated, the singular forms “a,” “an,” and “the” include plural reference.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, “sonolyzing,” “sonolysis,” “sonication,” or grammatical equivalents thereof refer to irradiating with high frequency sound such as, but not limited to, ultrasound. Such irradiation can be performed by employing sound frequencies of, for example, and without limitation, about 10 kHz to about 1,000 kHz. Sonolysis (a.k.a., sonication) may be carried out continuously or in multiple cycles, where each cycle includes an “on” state of a certain duration and an “off” state of a certain duration. For sonolysis, a variety of commercially available instruments, well known to the skilled artisan, may be utilized as a source of the sound waves used in the present methods. The sonolysis may be direct, i.e., the sonicator is in direct contact with the mixture being irradiated, or indirect, in which the vessel containing the mixture is irradiated, e.g., in a sonicating bath.

In one aspect, the present technology provides methods for manufacturing Pd-based metal oxides. The methods include sonolyzing a mixture including Pd(0) or a precursor thereof, water, and a first metal salt including a metal ion of formula ^{M1}(n+), wherein ^{M1} is any metal, other than Pd, having an oxidation state n+, and n is 2 or 3, to provide a Pd-based metal oxide including Pd, ^{M1} and oxygen.

In one embodiment, the mixture further includes a second metal salt including a metal ion of formula M²(n+), wherein M² is any metal, other than Pd, having the oxidation state n+, n is 2 or 3, and M¹ and M² are different metals, and the Pd-based metal oxide further includes M². In one embodiment, n is 2. In another embodiment, n is 3. In another embodiment, M¹ is a transition metal, other than Pd. In another embodiment, M² is a transition metal, other than Pd. In another embodiment, M¹ and M² are both transition metals, other than Pd.

In one embodiment, M¹ is Al, Ti, V, Cr, Mn, Fe, Co, Ni, Cu, Zn, Zr, Nb, Mo, Tc, Ru, Rh, Ag, Cd, Hf, Ta, W, Re, Os, Ir, Pt, Au, or Hg. In one embodiment, M² is Al, Ti, V, Cr, Mn, Fe, Co, Ni, Cu, Zn, Zr, Nb, Mo, Tc, Ru, Rh, Ag, Cd, Hf, Ta, W, Re, Os, Ir, Pt, Au, or Hg. In another embodiment, M¹ is Cu, Co, Mn, or Fe. In another embodiment, M¹ is Cu. In another embodiment, M¹ is Co. In another embodiment, M¹ is Mn. In another embodiment, M¹ is Fe. In another embodiment, M² is Cu, Co, Mn, or Fe. In another embodiment, M² is Cu. In another embodiment, M² is Co. In another embodiment, M² is Mn. In another embodiment, M² is Fe.

A variety of metal salts are useful in accordance with the methods provided herein. In one embodiment, the first metal salt includes an acetate, sulfate, chloride, oxalate, carbonate, or a nitrate salt. In another embodiment, the second metal salt includes an acetate, sulfate, chloride, oxalate, carbonate, or a nitrate salt. In another embodiment, the first and the second metal salts do not contain nitrate, do not contain nitrite or do not contain either nitrite or nitrate as an anion. However, in certain other embodiments, where a Pd-based metal oxide excluding sulfur or carbon is desired, the first metal salt, and if used, the second metal salt, can conveniently be nitrate or nitrite salts.

In one embodiment, the mixture includes Pd(0). In another embodiment, the mixture includes a Pd(0) precursor. The Pd(0) precursor may be, e.g., a Pd(2+) salt such as, but not limited to palladium acetate, palladium chloride, palladium sulfate, palladium nitrate, palladium carbonate, palladium oxalate, palladium acetylacetonate, palladium bromide, palladium cyanide, palladium fluoride, and palladium iodide. Thus, in one embodiment, the mixture may include a Pd(2+) ion and a reducing agent capable of reducing Pd(2+) to Pd(0). A variety of agents suitable for reducing Pd(2+) to Pd(0) may be used in accordance with the present methods. In one embodiment, the reducing agent is an alcohol that is capable of reducing Pd(2+) to Pd(0). For example, the reducing agent can be ethanol and/or benzyl alcohol. In another embodiment, the Pd(0) precursor is Pd(4+) salt, including but not limited to PdF₄ and PdO₂. Apart from palladium salts, Pd metal or Pd metal complexes in unsupported, supported, encapsulated, or stabilized forms may be used. The supported, encapsulated, or stabilized forms are contemplated to be supported, encapsulated, or stabilized by activated carbon, carbon nanotube, graphene, nickel, TiO₂, Al₂O₃, molecular sieves, dendrimers, polyvinyl pyrrolidone (PVP), or polyethylene glycol (PEG).

In another embodiment, the palladium salt is present in a concentration of at least about 0.005 mM, or at least about 0.01 mM, or at least about 0.05 mM, or at least about 0.1 mM, or at least about 1 mM. In another embodiment, the first metal salt is present in a concentration of about 1 mM to about 100 mM. Specific non-limiting examples of the concentration of the first metal salt include about 0.005 mM, about 0.01 mM, about 0.05 mM, is about 0.1 mM, about 1 mM, about 2 mM, about 5 mM, about 10 mM, about 20 mM, about 30 mM, about 40, about 50 mM, about 60 mM, about 70 mM, about 80 mM, about 90 mM, about 100 mM, and ranges between and including any two of these values. In one embodiment, the second metal salt is present in a concentration of about 1 mM to about 100 mM. Specific non-limiting examples of the concentration of the second metal salt include about 1 mM, about 2 mM, about 5 mM, about 10 mM, about 20 mM, about 30 mM, about 40, about 50 mM, about 60 mM, about 70 mM, about 80 mM, about 90 mM, about 100 mM, and ranges between and including any two of these values. In another embodiment, the ratio of the weight of the palladium metal or the palladium salt: the weight of the salt including M¹ and/or M² is about 1:1 to about 1:400. In another embodiment, the ratio is about 1:1, about 1:10, about 1:50, about 1:100, about 1:150, about 1:200, about 1:250, about 1:300, about 1:350, or about 1:400, and ranges between and including any two of these values.

The present methods provide Pd-based metal oxide particles in various sizes, depending on the amount of time the aqueous mixture of Pd and metal salts is sonicated, as well as % amplitude, pulse on/off ratio, and sonication temperature as tabulated below. Thus, a wide range of particle sizes on the nanometer and micrometer scales may be produced. By size is meant the average longest dimension of the particles. In one embodiment, the Pd-based metal oxide has a particle size of about 20 nm to about 10,000 nm. In one embodiment, the Pd-based metal oxide has a particle size of about 40 nm to about 100 nm, about 200 nm, about, 300 nm, about 400 nm, about 500 nm, or about 600 nm, or about 700 nm. In one embodiment, the Pd-based metal oxide has a particle size of about 20 nm to about 2,000 nm. In another embodiment, the Pd-based metal oxide has a particle size of about 250 nm to about 500 nm, about 300 nm to about 450 nm, or about 350 nm to about 400 nm Examples of Pd-based metal oxide particle sizes include but are not limited to about 20 nm, about 50 nm, about 100 nm, about 200 nm, about 250 nm, about 300 nm, about 400 nm, about 500 nm, about 600 nm, about 700 nm, about 800 nm, about 900 nm, about 1,000 nm, about 1,100 nm, about 1,200 nm, about 1,300 nm, about 1,400 nm, about 1,500 nm, about 1,600 nm, about 1,700 nm, about 1,800 nm, about 1,900 nm, about 2,000 nm, about 3,000 nm, about 4,000 nm, and 5,000 nm, about 6,000 nm, about 7,000 nm, about 8,000 nm, about 9,000 nm, about 10,000 nm, and about 15,000 nanometer (or about 15 micrometer), and ranges between and including any two of these values.

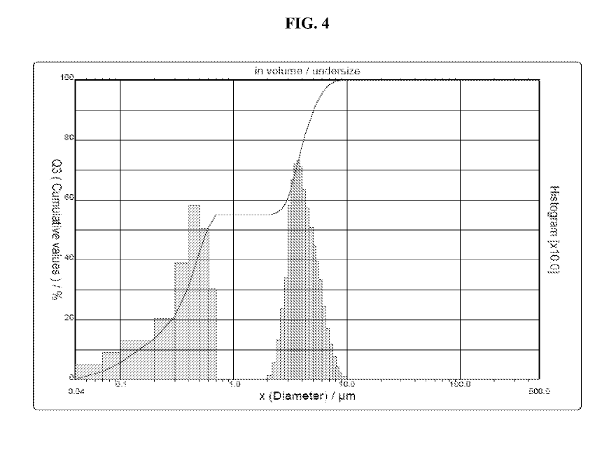

In an illustrative embodiment, FIG. 4 shows the distribution of particles containing Pd—Cu—O—C prepared in Example 1 in accordance to the methods provided herein. These mixture of particles may be separated into nano and micrometric sizes by filtration using, e.g., 0.2 micron filter, or may be converted to particles of reduced size by grinding or further sonication. The particles may have various shapes, and have rough and porous surfaces that lead to high activity. See, for example, SEM of six oxide samples in FIGS. 3A-3F, which were prepared by sonication according to the present methods and drying the wet slurry.

In some embodiments of the present methods, the Pd content of the Pd(0) or the precursor thereof is from about 0.1 wt % to about 99.9 wt % versus the metal content of M¹ or versus the metal content of M¹ and M². In an illustrative embodiment, M1 and M2 may be independently selected from the group consisting of Al, Ti, V, Cr, Mn, Fe, Co, Ni, Cu, Zn, Zr, Nb, Mo, Tc, Ru, Rh, Ag, Cd, Hf, Ta, W, Re, Os, Ir, Pt, Au, and Hg. For example, M¹ and/or M² can be Cu, Mn, Co or Fe. Examples of the Pd content of the Pd(0) or the precursor thereof include about 0.1 wt %, about 0.2 wt %, about 0.3 wt %, about 0.5 wt %, about 1 wt %, about 2 wt %, about 3 wt %, about 5 wt %, about 10 wt %, about 20 wt %, about 30 wt %, about 40 wt %, about 50 wt %, about 60 wt %, about 70 wt %, about 80 wt %, about 90 wt %, about 91 wt %, about 92 wt %, about 95 wt %, about 98 wt %, about 99 wt %, about 99.5 wt %, about 99.8 wt %, about 99.9 wt % versus the metal content of M¹ or versus the metal content of M¹ and M², and ranges between and including any two of these values.

The present methods provide a wide variety of Pd-based metal oxides of various elemental compositions. Thus, such Pd-based metal oxides may further include C, O, S, or combinations of any two or more thereof. It will be understood that the amounts of Pd, M¹, M², C, O, and S may be readily manipulated by suitable selection of Pd(0) or Pd(0) precursor and M¹ and (optionally) M² salts. In some embodiments, the Pd-based metal oxide includes about 0.25 wt % to about 70 wt % Pd or from about 2 wt % to about 60 wt % Pd. Examples of the Pd content of Pd-based metal oxides that may be prepared by the present methods include about 0.25 wt %, about 0.5 wt %, about 1 wt %, about 2 wt %, about 5 wt %, about 10 wt %, about 15 wt %, about 20 wt %, about 25 wt %, about 30 wt %, about 35 wt %, about 40 wt %, about 50 wt %, about 55 wt %, about 60 wt %, about 65 wt %, about 70 wt % Pd or ranges between and including any two such values.

In some embodiments, the Pd-based metal oxide produced includes about 0.1 wt % to about 60 wt % M¹ or from about 1 wt % to about 50 wt % M¹. Examples of the M¹ content of Pd-based metal oxides that may be prepared by the present methods include about 0.1 wt %, about 0.5 wt %, about 1 wt %, about 2 wt %, about 5 wt %, about 10 wt %, about 15 wt %, about 20 wt %, about 25 wt %, about 30 wt %, about 35 wt %, about 40 wt %, about 50 wt %, about 55 wt %, or about 60 wt % M¹ or ranges between and including any two such values. In some embodiments, the Pd-based metal oxide produced includes 0 wt % to about 60 wt % M² or from about 0.1 wt % to about 40 wt % M². Examples of the M² content of Pd-based metal oxides that may be prepared by the present methods include 0 wt %, about 0.1 wt %, about 0.5 wt %, about 1 wt %, about 2 wt %, about 5 wt %, about 10 wt %, about 15 wt %, about 20 wt %, about 25 wt %, about 30 wt %, about 35 wt %, about 40 wt %, about 50 wt %, about 55 wt %, or about 60 wt % M² or ranges between and including any two such values.

In some embodiments, the Pd-based metal oxide includes 0 wt % to about 35 wt % C. In other embodiments, the Pd-based metal oxide includes 0 wt % to about 20 wt % C. Examples of the C content of Pd-based metal oxides that may be prepared by the present methods include 0 wt %, about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, about 15 wt %, about 20 wt %, about 25 wt %, about 30 wt %, or about 35 wt %, or ranges between and including any two such values.

In certain embodiments, the Pd-based metal oxide includes about 5 wt % to about 60 wt % O or from about 8 wt % to about 60 wt % O. Examples of the O content of Pd-based metal oxides that may be prepared by the present methods include about 1 wt %, about 2 wt %, about 5 wt %, about 8 wt %, about 10 wt %, about 15 wt %, about 20 wt %, about 25 wt %, about 30 wt %, about 35 wt %, about 40 wt %, about 45 wt %, about 50 wt %, about 55 wt %, or about 60 wt % O or ranges between and including any two such values.

In some embodiments, the Pd-based metal oxide includes 0 wt % to about 30 wt % S, or from 0 wt % to about 15 wt %. Examples of the S content of Pd-based metal oxides that may be prepared by the present methods include 0 wt %, about 0.5 wt %, about 1 wt %, about 2 wt %, about 5 wt %, about 10 wt %, about 15 wt %, about 20 wt %, about 25 wt %, or about 30 wt % S or ranges between and including any two such values.

Thus, it will be understood by one skilled in the art, that the present methods provide Pd-based metal oxides including any of the above ranges of elements. In one illustrative embodiment, the Pd-based metal oxide includes: about 0.25 wt % to about 70 wt % Pd, about 0.1 wt % to about 60 wt % M¹, 0 wt % to about 35 wt % C, about 5 wt % to about 60 wt % O, and 0 wt % to about 30 wt % S. In some embodiments, the Pd-based metal oxide further includes 0 wt % to about 40 wt % M². In another illustrative embodiment, the Pd-based metal oxide includes: about 2 wt % to about 60 wt % Pd, about 1 wt % to about 50 wt % M¹, 0 wt % to about 35 wt % C, about 8 wt % to about 60 wt % O, and 0 wt % to about 15 wt % S. In yet another illustrative embodiment, the Pd-based metal oxide includes: about 20 wt % to about 55 wt % Pd, about 25 wt % to about 50 wt % M¹, about 1 wt % to about 10 wt % C, about 5 wt % to about 20 wt % O, and 0 wt % to about 15 wt % S.

A variety of sonicators, including without limitation, probe sonicators and bath sonicators, can be used in accordance with the present methods, i.e., for direct sonication of the mixture using a probe sonicator in contact with the mixture, and for indirect sonication using a bath sonicator for sonication of the vessel in which the mixture is placed. Either method or a combination of both direct and indirect sonolysis may be used to produce Pd-based oxides of the present technology. For sonicating the mixture in accordance with the present methods, the sonication can be suitably performed in various modes and for various times at various frequencies amplitudes and temperatures. For example, and without limitation, the sonication can employ a continuous mode or a pulse mode. For the pulse mode, various switch-on and switch-off times can be used. In one embodiment, the sonolyzing step includes one or more cycles of sonication, which cycles include about 1 second to about 10 seconds, about 2 seconds to about 9 seconds, about 3 seconds to about 8 seconds, about 4s second to about 7 seconds, or about 5 seconds to about 6 seconds of sonication, followed by no sonication for about 1 second to about 10 seconds, about 2 seconds to about 9 seconds, about 3 seconds to about 8 seconds, about 4 seconds to about 7 seconds, or about 5 seconds to about 6 seconds.

The sonication step of the present methods may be carried out for any length of time sufficient to provide the desired Pd-based metal oxides. In one embodiment, the sonication is carried out for about 3 hours, about 2.5 hours, about 2 hours, about 1.5 hours, about 1 hour, about 40 minutes, about 30 minutes, about 20 minutes, about 10 minutes, about 5 minutes, about 4 minutes, about 3 minutes, about 2 minutes, about 1 minute, or for times in between and including any of these values. In another embodiment, the sonolyzing step is performed for about 15 minutes to about 120 minutes.

In another embodiment, the sonicator employs a frequency of from about 10 kHz-about 1,000 kHz, about 20 kHz-about 400 kHz, about 30 kHz-about 300 kHz, 40 kHz-about 200 kHz, or about 50 kHz-about 100 kHz. In another embodiment, the sonolyzing step is performed at a frequency of about 15 kHz to about 25 kHz. The amplitude of the sonicator may range, e.g.,, from 1% to 100%. Examples of sonication amplitudes that may be employed include from about 1%, about 5%, about 10%, about 20%, about 25%, about 30%, about 40%, about 50%, about 60%, about 70%, about 80%, about 90%, about 100%, and ranges between and including any two of these values. In another embodiment, the sonicator employs a power of about 100 watts to about 1500 watts. Example sonicator powers include about 200 watts, about 300 watts, about 400 watts, about 500 watts, about 600 watts, about 800 watts, about 1000 watts, about 1200 watts, about 1500 watts, and ranges between and including any two of these values. Thus, a variety of acoustic intensities and acoustic power densities can be employed in accordance with the present technology.

The sonication can be suitably carried out under isothermal or non-isothermal conditions. In one embodiment, the sonication is carried out under isothermal conditions. Isothermal sonication may be typically done using the combination of a Suslick vessel and a circulator bath, but extra energy input is required for operating the circulator bath. In another embodiment, the sonication is performed under non-isothermal conditions. The sonication can be suitably carried out at various temperatures. In one embodiment, the temperature is from about 10° C. to about 100° C. Example temperatures include about 10° C., about 25° C., about 30° C., about 40° C. about 50° C., about 60° C., about 70° C., about 80° C., about 90° C., about 100° C., less than 100 ° C., and ranges between and including any two of these values. In another embodiment, the sonolyzing step is performed at a temperature ranging from about 25° C. to about 100° C.

The sonolysis may further include sparging the mixture with a gas during sonolysis. Air may be used for the sparging, but oxygen or inert gases such as nitrogen or argon may also be used. The gas may be introduced into the mixture using, e.g., plastic tubing and a simple aquarium pump.

While the slurry of Pd-based metal oxide resulting from sonolysis may be used “as is,” the present methods may further include isolating the Pd-based metal oxide and/or drying it. For example the slurry may be filtered to isolate the Pd-based metal oxide. The isolated particles may then be dried or further washed with the water or the sonolysis solution. Alternatively, the slurry may be centrifuged to concentrate the particles and the supernatant drawn off. Again, the resulting particles may be dried. Drying may be effected by heating (e.g., about 80° C. to about 100° C.), optionally under reduced pressure or in vacuo.

The presence/absence of the elements C, N and S in the final dry samples of metal oxides depends on the type of metal salt precursors used during the sonolysis. Under the experimented process conditions (the sonication conditions and the metal salt precursors used), nitrogen will not be present in the final dry sample and only C and S will be present either alone or together, depending on the types of metal salt precursors used during the sonolysis.Metal acetate precursors gave C and metal sulphate precursors gave S in the final dry sample.

In another aspect, the present technology provides the Pd-based metal oxide prepared by the methods of the present technology. Dry Pd-based metal oxides were characterized using SEM-EDX, X-ray powder diffraction (XRPD) and Brunauer, Emmett, and Teller (BET) methods to determine the chemical composition, crystal structure, and specific surface area. The results showed expected chemical composition as per the various precursor metal salts used. (See Examples.) The present methods produce Pd-based metal oxides with surface areas ranging, e.g., from about from about 30 to about 100 m²/g. In specific embodiments, the dry Pd-based metal oxide has a specific surface area of about 30 m²/g, about 50 m²/g, about 70m²/g, about 90 m²/g, about 100 m²/g, and ranges between and including any two of these values.

The technology having been described in summary and in detail is illustrated and not limited by the following examples.

### EXAMPLES

### Example 1

### Preparation of Pd-Based Oxides Using Pd(0) and Direct Sonolysis

Palladium metal (0.106 g, 1 mmol) was prepared as a micron sized powder by reducing palladium acetate with ethanol (20 mL) in water (70 mL), followed by evaporation of solvent and drying in air at an elevated temperature below 100 ° C. The Pd metal powder was dispersed in water (70 mL) to make a Pd-water slurry and copper acetate (0. 20 g, 1 mmol) was added to the mixture. The slurry was magnetically stirred for about 10 minutes and then irradiated directly by sonicating in an ultrasonic processor using a sonotrode as described below to give a slurry of black particles.

In an illustrative experimental procedure, a 750 W SONICS ultrasonic processor with a 13 2 mm probe operating at a fixed frequency of 20 kHz was used for direct sonication of the above mentioned reaction mixture at 18% amplitude. The ultrasonic process is operated in a pulse cycles of 8 seconds-5 seconds “on” and 3 seconds “off” periods—for a total duration of 90 minutes, under non-isothermal conditions. This experimental set up may be described as a sonochemical reactor.

Using the method described above, other oxides were also prepared as tabulated below.

TABLE 1

| | Pd metal/ | |
|---|---|---|
| | Pd | |
| Oxide | Acetate | Metal salts |
| Pd—Co—O—C | 1 mmol | 1 mmol Cobalt acetate |
| Pd—Fe—O—C—S | 1 mmol | 1 mmol Ferric sulfate |
| Pd—Cu—Fe—O—C—S | 1 mmol | 1 mmol Copper acetate, |
| | | 1 mmol Ferric sulfate |
| Pd—Cu—O—C S— | 1 mmol | 1 mmol Copper sulfate |
| Pd—Cu—O—C | 1 mmol | 1 mmol Copper acetate |
| Pd—Mn—O—C | 1 mmol | 1 mmol Manganese acetate |

### Example 2

### Preparation of Pd-Based Oxides Using Palladium Salts

Pd-based oxides were prepared directly using palladium salts as the precursor for making palladium metal by the alcohol-reduction method. For example, palladium acetate (0.224 g, 1 mmol) and copper acetate (0.200 g, 1 mmol) were transferred into a 100 mL glass vessel containing a mixture of ethyl alcohol-water (20 mL: 70 mL). The mixture was sonicated as described in Example 1.

### Example 3

### Preparation of Pd-Based Oxides in Accordance with DOE Principles

Pd-based metal oxides were also made using design of experiment (DOE) principles, where the sonication was conducted employing 18%-35% amplitude, on/off times of 5 seconds/1 second to 5 seconds/4 seconds, sonication time of 15 minutes to 60 minutes, and circulator bath temperature of 30° C. to 45° C. A minimum particle size of 350 nm was obtained under the following sonication conditions: time: 60 (min), percentage amplitude: 25 (%), on/off time: 5 seconds/1 second, temperature: 35° C. The frequency of sonication was fixed at 20 kHz. Based on the DOE principles, the variation of particle size was tested depending on reaction parameters. Table 2 shows the particle sizes obtained for various sonication conditions when the reaction mixture is 1 mmol copper acetate and 1 mmol palladium acetate.

TABLE 2

| | | | | | On/ | Circulator | |
|---|---|---|---|---|---|---|---|
| | | | | | Off | bath | Particle |
| Run | pH | pH | Time | % | Time | temperature | size |
| No. | before | after | (min) | Amplitude | (s/s) | (° C.) | (μm) |
| 1 | 5.09 | 3.75 | 15 | 18 | 5/1 | 30 | 1.67 |
| 2 | 5.11 | 3.91 | 30 | 25 | 5/2 | 30 | 6.02 |
| 3 | 5.10 | 3.91 | 45 | 30 | 5/3 | 30 | 5.76 |
| 4 | 5.11 | 3.93 | 60 | 35 | 5/4 | 30 | 0.38 |
| 5 | 5.09 | 3.82 | 45 | 18 | 5/2 | 35 | 0.37 |
| 6 | 5.09 | 3.90 | 60 | 25 | 5/1 | 35 | 0.35 |
| 7 | 5.09 | 3.79 | 15 | 30 | 5/4 | 35 | 0.38 |
| 8 | 5.09 | 3.80 | 30 | 35 | 5/3 | 35 | 2.83 |
| 9 | 5.09 | 3.93 | 60 | 18 | 5/3 | 40 | 0.37 |
| 10 | 5.09 | 3.90 | 45 | 25 | 5/4 | 40 | 0.36 |
| 11 | 5.09 | 3.84 | 30 | 30 | 5/1 | 40 | 1.16 |
| 12 | 5.11 | 3.81 | 15 | 35 | 5/2 | 40 | 1.37 |
| 13 | 5.12 | 3.75 | 30 | 18 | 5/4 | 45 | 2.57 |
| 14 | 5.10 | 3.68 | 15 | 25 | 5/3 | 45 | 2.03 |
| 15 | 5.09 | 3.94 | 60 | 30 | 5/2 | 45 | 2.11 |
| 16 | 5.10 | 3.85 | 45 | 35 | 5/1 | 45 | 1.39 |

Similar experiments were also performed where the amounts of the palladium salt and the copper salt was varied. The results from these experiments are tabulated below.

TABLE 3

| | | | | | | | | Temp | | | |
|---|---|---|---|---|---|---|---|---|---|---|---|
| Run | pH | pH | Time | % | On/Off | | Quantity | (° C.) | | Energy | Size |
| No. | (init.) | (final) | (min) | Amplitude | seconds | Pd(Ac)₂:Cu(Ac)₂ | (g) | Tᵢₙ | T_{final} | (in kJ) | (μm) |
| 1 | 5.67 | 4.84 | 10 | 30 | 5/0 | 1:100 | 0.002:0.2 | 30 | 58 | 16.03 | 3.35 |
| 2 | 5.62 | 4.92 | 10 | 30 | 5/0 | 1:200 | 0.001:0.2 | 31 | 60 | 15.7 | 3.02 |
| 3 | 5.53 | 4.81 | 30 | 30 | 5/0 | 1:400 | 0.001:0.4 | 32 | 67 | 39.2 | 1.09 |
| 4 | 5.58 | 5.04 | 10 | 25 | 5/0 | 1:100 | 0.002:0.2 | 29 | 55 | 13.6 | 5.66 |
| 5 | 5.58 | 5.11 | 10 | 25 | 5/0 | 1:200 | 0.001:0.2 | 29 | 56 | 13.7 | 3.18 |
| 6 | 5.60 | 4.79 | 30 | 25 | 5/0 | 1:400 | 0.001:0.4 | 29 | 57 | 34.8 | 2.54 |
| 7 | 5.65 | 5.09 | 15 | 20 | 5/0 | 1:100 | 0.002:0.2 | 28 | 52 | 10.8 | 5.33 |
| 8 | 5.64 | 5.10 | 20 | 20 | 5/0 | 1:200 | 0.001:0.2 | 29 | 56 | 13.9 | 3.52 |
| 9 | 5.57 | 4.84 | 45 | 20 | 5/0 | 1:400 | 0.001:0.4 | 29 | 64 | 31.5 | 2.42 |
| 10 | 5.67 | 5.15 | 30 | 18 | 5/0 | 1:100 | 0.002:0.2 | 29 | 62 | 16.16 | 2.24 |
| 11 | 5.66 | 5.18 | 30 | 18 | 5/0 | 1:200 | 0.001:0.2 | 29 | 63 | 16.68 | 2.34 |
| 12 | 5.55 | 5.21 | 45 | 18 | 5/0 | 1:400 | 0.001:0.4 | 29 | 62 | 35.2 | 1.38 |

TABLE 4

| | | | | | | | | Temp | | | |
|---|---|---|---|---|---|---|---|---|---|---|---|
| Run | pH | pH | time | | On/Off | Pd(Ac)₂ | Quantity | (° C.) | | Energy | Size |
| No. | (init.) | (final) | (min) | % Amplitude | seconds | Cu(Ac)₂ | (in g) | Tᵢₙ | T_{final} | (in kJ) | (μm) |
| 1 | 5.60 | 4.92 | 10 | 30 | 5/1 | 1:100 | 0.002:0.2 | 29 | 57 | 15.18 | 6.02 |
| 2 | 5.62 | 4.94 | 10 | 30 | 5/1 | 1:200 | 0.001:0.2 | 29 | 49 | 15.23 | 2.58 |
| 3 | 5.42 | 4.92 | 15 | 30 | 5/1 | 1:400 | 0.001:0.4 | 30 | 52 | 20.82 | 2.10 |
| 4 | 5.64 | 5.05 | 10 | 25 | 5/1 | 1:100 | 0.002:0.2 | 29 | 55 | 13.23 | 3.06 |
| 5 | 5.62 | 5.74 | 10 | 25 | 5/1 | 1:200 | 0.001:0.2 | 28 | 54 | 12.78 | 3.46 |
| 6 | 5.57 | 4.94 | 20 | 25 | 5/1 | 1:400 | 0.001:0.4 | 30 | 62 | 29.68 | 2.83 |
| 7 | 5.65 | 5.60 | 20 | 20 | 5/1 | 1:100 | 0.002:0.2 | 28 | 52 | 13.20 | 5.46 |
| 8 | 5.65 | 4.92 | 30 | 20 | 5/1 | 1:200 | 0.001:0.2 | 26 | 56 | 20.60 | 3.59 |
| 9 | 5.62 | 4.86 | 70 | 20 | 5/1 | 1:400 | 0.001:0.4 | 28 | 61 | 46.00 | 2.25 |
| 10 | 5.50 | 5.00 | 30 | 18 | 5/1 | 1:100 | 0.002:0.2 | 29 | 58 | 15.16 | 3.23 |
| 11 | 5.55 | 5.05 | 30 | 18 | 5/1 | 1:200 | 0.001:0.2 | 28 | 59 | 14.96 | 3.12 |
| 12 | 5.52 | 5.02 | 90 | 18 | 5/1 | 1:400 | 0.001:0.4 | 25 | 54 | 50.8 | 1.58 |

TABLE 5

| | | | | | | | | Temp | | | |
|---|---|---|---|---|---|---|---|---|---|---|---|
| Run | pH | pH | time | | On/Off | Pd(Ac)₂ | Quantity | (° C.) | | Energy | Size |
| No. | (init.) | (final) | (min) | % Amplitude | seconds | Cu(Ac)₂ | (g) | Tᵢₙ | T_{final} | (in kJ) | (μm) |
| 1 | 5.60 | 5.01 | 15 | 30 | 5/2 | 1:100 | 0.002:0.2 | 28 | 61 | 22.01 | 5.02 |
| 2 | 5.55 | 5.06 | 20 | 30 | 5/2 | 1:200 | 0.001:0.2 | 29 | 55 | 15.4 | 3.74 |
| 3 | 5.58 | 5.82 | 20 | 30 | 5/2 | 1:400 | 0.001:0.4 | 29 | 63 | 26.5 | 1.08 |
| 4 | 5.55 | 5.05 | 10 | 25 | 5/2 | 1:100 | 0.002:0.2 | 28 | 58 | 13.2 | 1.75 |
| 5 | 5.56 | 4.98 | 20 | 25 | 5/2 | 1:200 | 0.001:0.2 | 28 | 52 | 20.9 | 1.70 |
| 6 | 5.58 | 4.98 | 30 | 25 | 5/2 | 1:400 | 0.001:0.4 | 29 | 63 | 27.06 | 1.11 |
| 7 | 5.52 | 5.12 | 15 | 20 | 5/2 | 1:100 | 0.002:0.2 | 29 | 56 | 9.11 | 3.86 |
| 8 | 5.53 | 5.07 | 20 | 20 | 5/2 | 1:200 | 0.001:0.2 | 31 | 52 | 12.2 | 2.42 |
| 9 | 5.61 | 5.10 | 30 | 20 | 5/2 | 1:400 | 0.001:0.4 | 30 | 54 | 17.7 | 1.96 |
| 10 | 5.51 | 5.14 | 20 | 18 | 5/2 | 1:100 | 0.002:0.2 | 29 | 52 | 10.2 | 2.42 |
| 11 | 5.57 | 5.11 | 20 | 18 | 5/2 | 1:200 | 0.001:0.2 | 29 | 48 | 10.06 | 1.55 |
| 12 | 5.61 | 5.16 | 30 | 18 | 5/2 | 1:400 | 0.001:0.4 | 29 | 49 | 14.4 | 2.57 |

TABLE 6

| | | | | | | | | Temp | | | |
|---|---|---|---|---|---|---|---|---|---|---|---|
| Run | pH | pH | time | | On/Off | Pd(Ac)₂ | Quantity | (° C.) | | Energy | Size |
| No. | (init.) | (final) | (min) | % Amplitude | seconds | Cu(Ac)₂ | (g) | Tᵢₙ | T_{final} | (in kJ) | (μm) |
| 1 | 5.7 | 5.14 | 10 | 30 | 5/3 | 1:100 | 0.002:0.2 | 28 | 52 | 18.9 | 3.09 |
| 2 | 5.68 | 5.05 | 10 | 30 | 5/3 | 1:200 | 0.001:0.2 | 29 | 56 | 18.63 | 2.96 |
| 3 | 5.52 | 5.04 | 30 | 30 | 5/3 | 1:400 | 0.002:0.8 | 31 | 63 | 55.5 | 2.47 |
| 4 | 5.76 | 5.01 | 20 | 25 | 5/3 | 1:100 | 0.002:0.2 | 29 | 57 | 20.6 | 3.44 |
| 5 | 5.74 | 5.12 | 20 | 25 | 5/3 | 1:200 | 0.001:0.2 | 29 | 54 | 16.06 | 3.42 |
| 6 | 5.83 | 5.04 | 60 | 25 | 5/3 | 1:400 | 0.002:0.8 | 29 | 58 | 24.12 | 2.36 |
| 7 | 5.49 | 5.15 | 30 | 20 | 5/3 | 1:100 | 0.002:0.2 | 28 | 49 | 18.30 | 3.33 |
| 8 | 5.78 | 5.12 | 30 | 20 | 5/3 | 1:200 | 0.001:0.2 | 28 | 51 | 18.32 | 4.79 |
| 9 | 5.76 | 5.16 | 60 | 20 | 5/3 | 1:400 | 0.002:0.8 | 28 | 59 | 31.91 | 4.81 |
| 10 | 5.67 | 5.12 | 60 | 18 | 5/3 | 1:200 | 0.001:0.2 | 29 | 49 | 36.3 | 2.35 |
| 11 | 5.73 | 5.02 | 60 | 18 | 5/3 | 1:400 | 0.002:0.8 | 29 | 48 | 29.3 | 3.71 |
| 12 | 5.63 | 5.02 | 60 | 18 | 5/3 | 1:400 | 0.001:0.2 | 28 | 50 | 29.2 | 3.52 |
| 13 | 5.65 | 5.12 | 60 | 18 | 5/3 | 1:200 | 0.001:0.2 | 29 | 49 | 34.29 | 2.72 |

TABLE 7

| | | | | | | | Water:Alcohol | Temp | | | |
|---|---|---|---|---|---|---|---|---|---|---|---|
| Run | pH | pH | time | | On/Off | Pd(Ac)₂ | (Volume | (° C.) | | Energy | Size |
| No. | (init.) | (final) | (min) | % Amplitude | seconds | Cu(Ac)₂ | (Ratio) | Tᵢₙ | T_{final} | (in gJ) | (μm) |
| 1 | 5.61 | 4.81 | 15 | 30 | 5/0 | 1:200 | 60:30 | 28 | 63 | 21.96 | 3.36 |
| 2 | 5.59 | 4.90 | 15 | 30 | 5/0 | 1:200 | 50:40 | 27 | 62 | 21.8 | 4.96 |
| 3 | 5.58 | 5.05 | 15 | 30 | 5/0 | 1:200 | 45:45 | 26 | 63 | 21.20 | 5.23 |
| 4 | 5.74 | 4.78 | 15 | 30 | 5/1 | 1:200 | 60:30 | 29 | 63 | 21.42 | 3.30 |
| 5 | 5.68 | 5.1 | 15 | 30 | 5/1 | 1:200 | 50:40 | 29 | 62 | 20.68 | 4.53 |
| 6 | 5.68 | 4.90 | 15 | 30 | 5/1 | 1:200 | 45:45 | 28 | 62 | 20.70 | 4.63 |
| 7 | 5.64 | 4.88 | 35 | 30 | 5/2 | 1:200 | 60:30 | 28 | 66 | 41.90 | 1.84 |
| 8 | 5.62 | 4.60 | 45 | 30 | 5/2 | 1:200 | 50:40 | 27 | 66 | 47.37 | 5.18 |
| 9 | 5.62 | 4.95 | 45 | 30 | 5/2 | 1:200 | 45:45 | 27 | 62 | 45.40 | 4.69 |
| 10 | 5.72 | 4.85 | 45 | 30 | 5/3 | 1:200 | 60:30 | 28 | 63 | 42.80 | 1.61 |

The effect of sonication time, amplitude, on/off time, and temperature on the particle size was determined based on the results obtained above, employing a regression analysis. The regression analysis showed the particle size to vary with time, amplitude, on/off duration, and temp as follows:

Particle Size=5.39−0.0190 [Time]+0.0216 [Amplitude]−0.038 [On/Off]−0.0893 [Temp].

A response table for means (Table 8) is shown below. It was determined that sonication time, temperature and on/off time had more effect on the particle size as compared to the % amplitude (rank 4).

TABLE 8

| Level | Time | % Amplitude | On/Off (s) | Temp (° C.) |
|---|---|---|---|---|
| 1 | 1.3625 | 1.2450 | 1.1425 | 3.4575 |
| 2 | 3.1450 | 2.1900 | 2.4675 | 0.9825 |
| 3 | 1.9700 | 2.3525 | 2.7475 | 0.8150 |
| 4 | 0.8025 | 1.4925 | 0.9225 | 2.0250 |
| Delta | 2.3425 | 1.1075 | 1.8250 | 2.6425 |
| Rank | 2 | 4 | 3 | 1 |

### Example 4

### Composition and Physical Analysis of Pd-Based Oxides

SEM-EDX analysis was carried out using a JEOL 6380 machine; voltage, 20.0 kV; probe current, 1.00 nA; energy range, 0-20 keV.

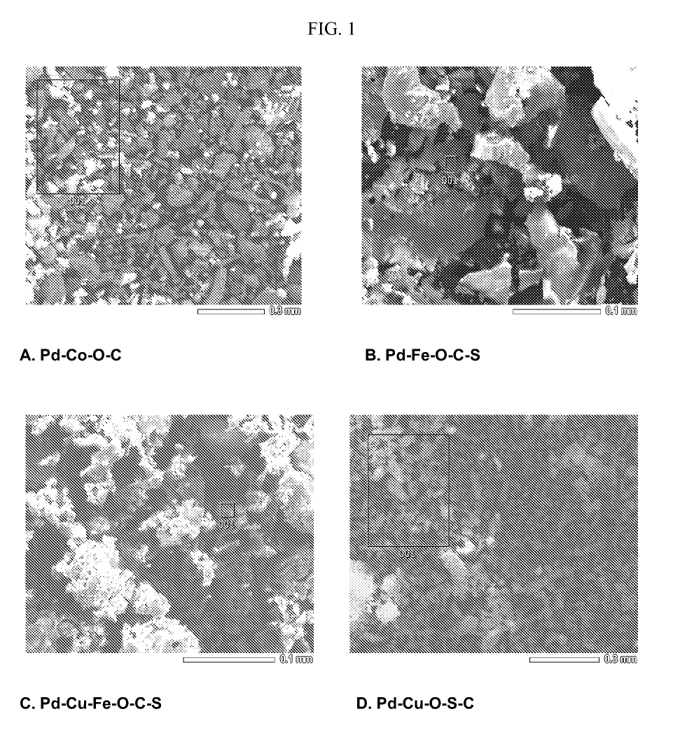

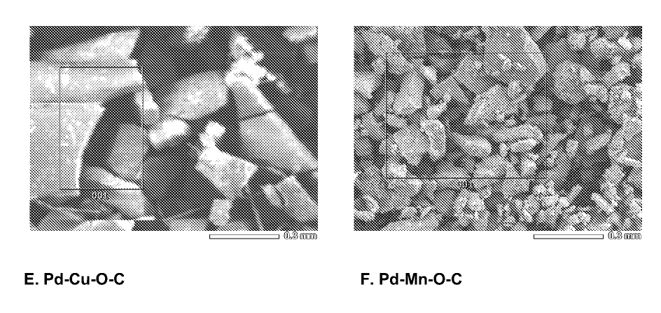

The surface compositions of various Pd-based metal oxides prepared in accordance with the present technology were measured using SEM-EDX analysis and are tabulated below in Tables 9-15. The components corresponding to the oxide characterized in each table is parenthetically indicated next to the table number. The SEM images for these compositions are shown in FIGS. 1A-1F.

TABLE 9
(Pd—Cu—O—C)

| | Kilo | | | | |
|---|---|---|---|---|---|
| | Electronvolts | | | | |
| Element | (keV) | Mass % | Error % | Atom % | K |
| C K | 0.277 | 10.23 | 0.07 | 24.81 | 4.1857 |
| O K | 0.525 | 28.96 | 0.16 | 52.71 | 21.4569 |
| Cu K | 8.040 | 31.58 | 0.38 | 14.47 | 40.4271 |
| Pd L | 2.838 | 29.23 | 0.17 | 8.00 | 33.9303 |
| Total | | 100.00 | | 100.00 | |

TABLE 10
(Pd—Cu—O—S—C)

| | Kilo | | | | |
|---|---|---|---|---|---|
| | Electronvolts | | | | |
| Element | (keV) | Mass % | Error % | Atom % | K |
| C K | 0.277 | 7.54 | 0.13 | 16.06 | 1.7432 |
| O K | 0.525 | 38.17 | 0.14 | 61.03 | 33.7064 |
| S K | 2.307 | 8.91 | 0.06 | 7.11 | 11.5672 |
| Cu K | 8.040 | 30.16 | 0.43 | 12.14 | 36.8249 |
| Pd L | 2.838 | 15.22 | 0.19 | 3.66 | 16.1583 |
| Total | | 100.00 | | 100.00 | |

TABLE 11
(Pd—Mn—O—C)

| | Kilo | | | | |
|---|---|---|---|---|---|
| | Electronvolts | | | | |
| Element | (keV) | Mass % | Error % | Atom % | K |
| C K | 0.277 | 9.47 | 0.06 | 25.92 | 6.8378 |
| O K | 0.525 | 24.18 | 0.33 | 49.72 | 12.8687 |
| Mn K | 5.894 | 13.25 | 0.29 | 7.94 | 15.9620 |
| Pd L | 2.838 | 53.10 | 0.23 | 16.42 | 64.3314 |
| Total | | 100.00 | | 100.00 | |

TABLE 12
(Pd—Co—O—C)

| | Kilo | | | | |
|---|---|---|---|---|---|
| | Electronvolts | | | | |
| Element | (keV) | Mass % | Error % | Atom % | K |
| C K | 0.277 | 17.73 | 0.06 | 35.19 | 11.6137 |
| O K | 0.525 | 34.41 | 0.26 | 51.27 | 24.1784 |
| Co K | 6.924 | 15.61 | 0.34 | 6.32 | 21.4541 |
| Pd L | 2.838 | 32.24 | 0.22 | 7.22 | 42.7538 |
| Total | | 100.00 | | 100.00 | |

TABLE 13
(Pd—Fe—O—C—S)

| | Kilo | | | | |
|---|---|---|---|---|---|
| | Electronvolts | | | | |
| Element | (keV) | Mass % | Error % | Atom % | K |
| C K | 0.277 | 4.66 | 0.15 | 10.73 | 1.0611 |
| O K | 0.525 | 33.96 | 0.14 | 58.65 | 35.0235 |
| S K | 2.307 | 6.08 | 0.08 | 5.24 | 6.6560 |
| Fe K | 6.398 | 46.91 | 0.29 | 23.21 | 49.5995 |
| Pd L | 2.838 | 8.39 | 0.26 | 2.18 | 7.6598 |
| Total | | 100.00 | | 100.00 | |

TABLE 14
(Pd—Cu—Fe—O—C—S)

| | Kilo | | | | |
|---|---|---|---|---|---|
| | Electronvolts | | | | |
| Element | (keV) | Mass % | Error % | Atom % | K |
| C K | 0.277 | 4.02 | 0.17 | 8.99 | 0.7061 |
| O K | 0.525 | 36.16 | 0.14 | 60.72 | 31.8268 |
| S K | 2.307 | 14.64 | 0.06 | 12.27 | 18.0366 |
| Fe K | 6.398 | 17.56 | 0.23 | 8.45 | 20.7004 |
| Cu K | 8.040 | 15.31 | 0.47 | 6.47 | 16.9141 |
| Pd L | 2.838 | 12.31 | 0.21 | 3.11 | 11.8160 |
| Total | | 100.00 | | 100.00 | |

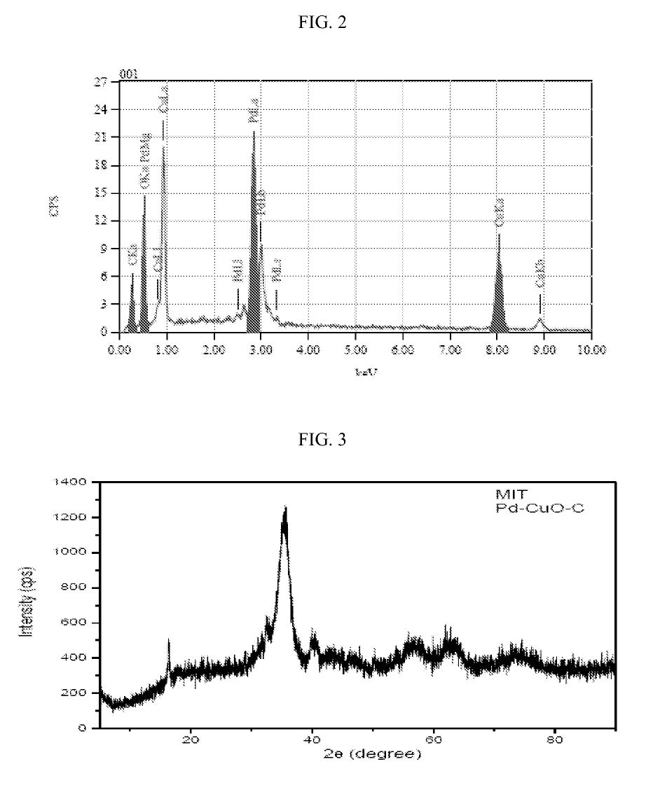

The SEM-EDX spectrum for the Pd-based metal oxide of general formula Pd—Cu—O—C is shown in FIG. 2. As the SEM-EDX data provides only surface compositions, the overall composition for each of the above Pd-based metal oxides was calculated as set forth in Table 15.

TABLE 15

| | | | Wt % | | | | | |
|---|---|---|---|---|---|---|---|---|
| | | | | | | | M¹ | M² |
| No. | Composition, MW | | O | C | S | Pd | (Cu/Mn/Co/Fe) | (Fe) |
| 1 | Pd—CuO—C | 197.97 | 8 | 6 | 0 | 53.8 | 32.1 | 0 |
| 2 | Pd—CuO—S—C | 229.97 | 7 | 5.2 | 13.9 | 46.3 | 27.6 | 0 |
| 3 | Pd—MnO₂—C | 205.4 | 15.6 | 5.8 | 0 | 51.8 | 26.7 | 0 |
| 4 | Pd—Co₃O₄—C | 359.22 | 17.8 | 3.3 | 0 | 29.6 | 49.2 | 0 |
| | (Co₃O₄═CoO + Co₂O₃) | | | | | | | |
| 5 | Pd—Fe₃O₄—C—S | 381.95 | 16.8 | 3.1 | 8.3 | 27.9 | 43.9 | 0 |
| 6 | Pd—CuO—Fe₃O₄—C—S | 461.5 | 17.3 | 2.6 | 6.9 | 23.1 | 13.8 | 36.3 |

X-ray powder diffraction was carried out on the Pd-based metal oxide of general formula Pd—Cu—O—C and is shown in FIG. 3. The conditions under which the XRPD spectrum was obtained were as follows. The XRPD pattern of the material was recorded using Rigaku Miniflex II desktop X-ray diffractometer operated at 30 kV and 15 mA using CuKα radiation (λ=1.5418 Å) at a scan rate of 1°/min. The diffraction profiles were obtained in the scan range (2θ) of 5-90° . The interlayer spacing is calculated from the Bragg equation as shown below:

d=nλ/2Sin θ

where λ is the wave length of the radiation (CuKα) used, and θ is the diffraction angle for the peak position.

### Example 5

### Preparation of Benzaldehyde

Palladium oxide-based catalyst was synthesized according to the procedure of Example 1 except that about 80 wt % PVP (based on the weight of the Pd metal) was added to provide the mixed catalyst [PVP-Pd—Cu—OC]. The latter was tested as an oxidative catalyst for the synthesis of aldehydes from alcohols, specifically for the liquid phase catalytic oxidation of benzyl alcohol to benzaldehyde. The oxidation was carried out under mild conditions: atmospheric pressure and 30 ° C., using either hydrogen peroxide, air, or oxygen. Table 16 shows various conditions explored, including sonication of Experiments 5 and 6. Conversions of up to 30% of the benzyl alcohol were achieved.

TABLE 16

| | | Catalyst | | | | |
|---|---|---|---|---|---|---|
| | | Loading | | | | |
| | Temp. | (g cat/cc | Benzyl Alcohol/ | | Time | % |
| Expt. | deg C. | alcohol | Oxidant ratio | Initiator | hrs | Conv. |
| 1 | 30 | 0.005 | 1:1 | Nil | 1 | 19 |
| | | | 30% H₂O₂ | | | |
| 2 | 30 | 0.01 | 1:1.5 | Nil | 2 | 20 |
| | | | 30% H₂O₂ | | | |
| 3 | 30 | 0.02 | 1:2 | Nil | 3 | 22 |
| | | | 30% H₂O₂ | | | |
| 4 | 30 | 0.03 | 1:2.5 | nil | 4 | 30 |
| | | | 30% H₂O₂ | | | |
| 5 | Non-Isothermal | 0.005 | (20 mL Alcohol + | 10 mL | 3 | 13 |
| | Amplitude: 25% | | 210 mL water) + | 30% H₂O₂ | | |
| | Pulse: 5 s On/3 s | | Air | | | |
| | Off | | | | | |
| 6 | Non-Isothermal | 0.0165 | (40 mL alcohol + | 10 mL | 3 | 20 |
| | Amplitude: 25%, | | 210 mL water) + | 30% H₂O₂ | | |
| | Pulse: 5 s On/1 s Off | | Oxygen | | | |

The percentage conversion to benzaldehyde was monitored by gas chromatography. Samples taken from the reactor were centrifuged to separate the solid catalyst, aqueous and the organic phases. The organic phase was analyzed using CHEMITO (Thermo Fisher) Gas Chromatograph using an FID detector under the following temperature programming.

Column Details: 10% OV 17 SS column, ⅛ in i.d., 4 m length
Injector temperature: 300° C., Detector temperature: 300° C.
Oven temperature (Temperature Programming):
Initial temperature: 175° C.
Rate of heating: 20° C./min,
Final temperature & holding time: 275° C., 5 min
   Gas pressures: Nitrogen: 3.6 bar, Hydrogen: 2 bar, Air: 1 bar.

### Example 6

### Preparation of Pd-Based Oxides Using Indirect and Direct Sonolysis

Pd—Cu—O—C was prepared according to the procedures given in Example 1 except that instead of direct sonolysis using an ultrasonic probe, the vessel containing the reaction mixture was continuously indirectly sonolyzed in an ultrasonic bath at the same time (Mark MU 2500, 120 W, 30-36 kHz, 2.5 L capacity). Temperature control was non-isothermal. Each reaction mixture contained Pd and copper acetate in 90 mL water. Air was bubbled into the reaction mixture using an aquarium pump. Conditions for the 16 experiments performed are provided in Table 17 below.

TABLE 17

| | | | Pulse | Sonication | Average |
|---|---|---|---|---|---|
| Expt. | Salt ratio (g:g) | % | ON/OFF | Time | Particle Size |
| No. | Pd:Cu(Ac)₂ | Amplitude | (s)/(s) | (min) | (microns) |
| 1 | 0.08:0.40 | 30 | 5/1 | 10 | 1.29 |
| 2 | 0.08:0.40 | 35 | 5/2 | 20 | 0.80 |
| 3 | 0.08:0.40 | 40 | 5/3 | 30 | 2.82 |
| 4 | 0.08:0.40 | 45 | 5/4 | 40 | 3.31 |
| 5 | 0.09:0.45 | 30 | 5/2 | 30 | 3.59 |
| 6 | 0.09:0.45 | 35 | 5/1 | 40 | 3.70 |
| 7 | 0.09:0.45 | 40 | 5/4 | 10 | 5.70 |
| 8 | 0.09:0.45 | 45 | 5/3 | 20 | 3.15 |
| 9 | 0.10:0.50 | 30 | 5/3 | 40 | 4.80 |
| 10 | 0.10:0.50 | 35 | 5/4 | 30 | 3.69 |
| 11 | 0.10:0.50 | 40 | 5/1 | 20 | 4.73 |
| 12 | 0.10:0.50 | 45 | 5/2 | 10 | 3.83 |
| 13 | 0.11:0.55 | 30 | 5/4 | 20 | 4.28 |
| 14 | 0.11:0.55 | 35 | 5/3 | 10 | 3.10 |
| 15 | 0.11:0.55 | 40 | 5/2 | 40 | 4.25 |
| 16 | 0.11:0.55 | 45 | 5/1 | 30 | 1.99 |

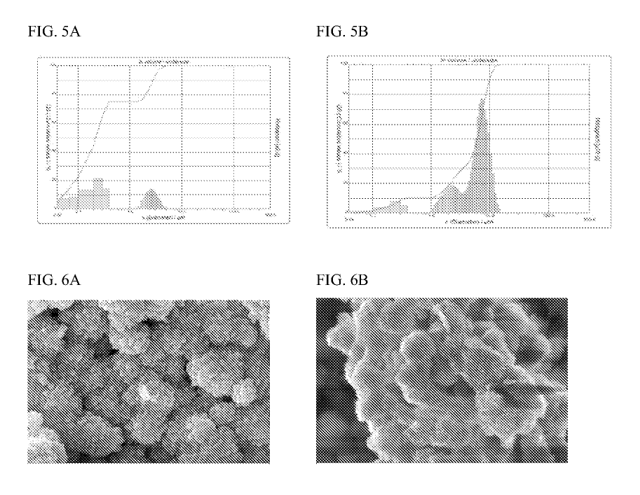

The conditions of the present Example show improved homogeneity of particle size and how the mean particle size may be controlled. For example, experiment 2 conditions in Table 17 provided a mean particle size of 0.8 μm (see FIGS. 5A and 6A for a histogram of particle sizes and SEM image, respectively). In contrast, the conditions of experiment 7 in Table 17 provided a mean particle size of 5.7 μm (see FIGS. 5B and 6B 6A for a histogram of particle sizes and SEM image, respectively).

### EQUIVALENTS

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms ‘comprising,’ ‘including,’ ‘containing,’ etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase ‘consisting essentially of’ will be understood to include those elements specifically recited and those additional elements that do not materially affect the basic and novel characteristics of the claimed technology. The phrase ‘consisting of’ excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compounds, compositions, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, or compounds, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as ‘up to,’ ‘at least,’ ‘greater than,’ ‘less than,’ and the like, include the number recited and refer to ranges which can be subsequently broken down into subranges as discussed above. Finally, as will be understood by one skilled in the art, a range includes each individual member.

Other embodiments are set forth in the following claims.

1. A method of manufacture comprising:
sonolyzing a mixture comprising Pd(0) or a precursor thereof, water and a first metal salt comprising a metal ion of formula M¹(n+), wherein M¹ is any metal, other than Pd, having an oxidation state n+, and n is 2 or 3, to provide a Pd-based metal oxide comprising Pd, M¹ and oxygen.

2. The method of claim 1, wherein the mixture further comprises:
a second metal salt comprising a metal ion of formula M²(n+), wherein M² is any metal, other than Pd, having the oxidation state n+, n is 2 or 3, and M¹ and M² are different metals, and the Pd-based metal oxide further comprises M².

3. The method of claim 1 wherein M¹ is a transition metal other than Pd, and M² is a transition metal other than Pd.

4. The method of claim 1 wherein:
M¹ is Al, Ti, V, Cr, Mn, Fe, Co, Ni, Cu, Zn, Zr, Nb, Mo, Tc, Ru, Rh, Ag, Cd, Hf, Ta, W, Re, Os, Ir, Pt, Au, or Hg; and
M² is Al, Ti, V, Cr, Mn, Fe, Co, Ni, Cu, Zn, Zr, Nb, Mo, Tc, Ru, Rh, Ag, Cd, Hf, Ta, W, Re, Os, Ir, Pt, Au, or Hg.

5. The method of claim 1 wherein M¹ is Cu, Co, Mn, or Fe; and M² is Cu, Co, Mn, or Fe.

6. The method of claim 1 wherein the first metal salt, the second metal salt, or each of the first and second metal salts is an acetate, sulfate, carbonate, oxalate, chloride, or nitrate salt.

7. The method of claim 1, wherein the mixture comprises:
a Pd(2+) ion and a reducing agent capable of reducing Pd(2+) to Pd(0).

8. The method of claim 7 wherein the reducing agent is ethanol or benzyl alcohol.

9. The method of claim 1, wherein the mixture comprises Pd(0).

10. The method of claim 1, wherein the mixture does not comprise a nitrate anion, and the mixture does not comprise a nitrite anion.

11. The method of claim 1, wherein the sonolyzing step comprises direct sonolysis, indirect sonolysis, or both direct and indirect sonolysis.

12. The method of claim 1, wherein the sonolyzing step comprises one or more cycles of sonication for 1 second to 10 seconds followed by no sonication for 1 second to 10 seconds.

13. The method of claim 1, wherein the sonolyzing step is performed for 15 minutes to 120 minutes.

14. The method of claim 1, wherein the sonolyzing step is performed at a frequency of about 15 kHz to about 25 kHz.

15. The method of claim 1, further comprising sparging the mixture with a gas during sonolysis.

16. The method of claim 1, wheren the sonolyzing step is performed at a temperature ranging from about 10° C. to about 100° C.

17. The method of claim 1, wherein the Pd-based metal oxide has a particle size of about 20 nm to about 200 nm.

18. The method of claim 1, wherein the Pd content of the Pd(0) or the precursor thereof is from about 0.1 wt % to about 99.9 wt % versus the metal content of M¹.

19. The method of claim 2, wherein the Pd content of the Pd(0) or the precursor thereof is from about 0.1 wt % to about 99.9 wt % versus the metal content of M¹ and M².

20. The method of claim 1, wherein the Pd content of the Pd(0) or the precursor thereof is from about 0.1 wt % to about 99.9 wt % versus the metal content of M¹ selected from the group consisting of Al, Ti, V, Cr, Mn, Fe, Co, Ni, Cu, Zn, Zr, Nb, Mo, Tc, Ru, Rh, Ag, Cd, Hf, Ta, W, Re, Os, Ir, Pt, Au, and Hg.

21. The method of claim 2, wherein the Pd content of the Pd(0) or the precursor thereof is from about 0.1 wt % to about 99.9 wt % versus the metal content of M¹ and M², wherein M² is selected from the group consisting of Al, Ti, V, Cr, Mn, Fe, Co, Ni, Cu, Zn, Zr, Nb, Mo, Tc, Ru, Rh, Ag, Cd, Hf, Ta, W, Re, Os, Ir, Pt, Au, and Hg.

22. The method of claim 20, wherein the M¹ is Cu, Mn, Co or Fe.

23. The method of claim 1, wherein the Pd-based metal oxide further comprises C, O, S, or combinations of any two or more thereof

24. The method of claim 1, wherein the Pd-based metal oxide comprises:
about 0.25 wt % to about 70 wt % Pd, about 0.1 wt % to about 60 wt % M¹, 0 wt % to about 35 wt % C, about 5 wt % to about 50 wt % O, and 0 wt % to about 30 wt % S.

25. The method of claim 23, wherein the Pd-based metal oxide further comprises 0.1 wt % to about 60 wt % M².

26. The Pd-based metal oxide prepared by the method of claim 1.
